(19) United States
(12) Patent Application Publication
(10) Pub. No.: US 2011/0125778 A1
(43) Pub. Date: May 26, 2011

(54) STREAM DATA PROCESSING METHOD, RECORDING MEDIUM, AND STREAM DATA PROCESSING APPARATUS

(75) Inventor: Eri KUBO, Yokohama (JP)

(73) Assignee: Hitachi, Ltd.

(21) Appl. No.: 12/715,012

(22) Filed: Mar. 1, 2010

(30) Foreign Application Priority Data
Nov. 26, 2009 (JP) 2009-268689

(51) Int. Cl. G06F 17/30

(52) U.S. Cl. 707/769; 707/E17.014

(57) ABSTRACT

A stream data processing method to be used in a stream data processing apparatus that receives stream data including time information, the steam data processing method comprising: calculating an input interval and a first reference time; a second step of calculating, a second reference time based on the first reference time and the input interval; and, a third step of generating stream data having new time information based on the second reference time.

### CLAIM OF PRIORITY

The present application claims priority from Japanese patent application 2009-268689 filed on Nov. 26, 2009, the content of which is hereby incorporated by reference into this application.

### BACKGROUND OF THE INVENTION

This invention relates to a stream data processing method and a program, and more particularly, to a stream data processing method of simultaneously processing a plurality of streams, and a recording medium.

In recent years, development of information and communication technologies has been accompanied by a considerable increase in amount of information data processed by an application.

In a conventional database management system (DBMS), received data is temporarily stored in a storage area of a database or the like, and then batch processing is performed by using the received data stored in the storage area. The temporary storage of the received data in the database therefore causes a time lag. When the amount of data considerably increases, an amount of calculation linearly increases. Hence, some applications may not be able to provide satisfactory processing performance demanded by clients.

In view of future development of information and communication technologies, it is essential to improve performance of the IT platform. Thus, a stream data processing system that enables real-time aggregation and analysis is attracting attention.

The stream data processing system targets stream data for calculation. The stream data refers to a data sequence that incessantly arrives in time series. For example, RFID read information, traffic information, or stock price information corresponds to stream data.

In the stream data processing system, data processing is performed according to a predefined scenario. The scenario uses the continuous query language (CQL) as disclosed in, for example, JP 2006-338432 A. The CQL is an extension of the structured query language (SQL) widely used in the DBMS. The CQL is used to write a scenario in the form of a query as in the case of the SQL. A query of the stream data processing system is different from that of the conventional SQL in the following points.

The first point is in that the scenario is constituted by a plurality of join queries. For example, as disclosed in JP 09-34759 A, the conventional SQL is used for processing that targets one input and one output, and the processing is constituted by a single query.

On the other hand, in the stream data processing system, a plurality of queries are joined to calculate an intermediate result. Thus, complex data processing that cannot be implemented by a single query can be performed.

The second point is introduction of a concept of a unique window as disclosed in, for example, JP 2006-338432 A. The stream data continuously arrives without any breaks. Hence, to extract data of a calculation target, time-sequential data must be divided into bounded data aggregates. Thus, in the stream data processing system, a concept of a window (sliding window) is introduced, and difference calculation that targets a window change difference is employed.

Sliding windows are largely classified into two types which are specifically a window for holding n most recent pieces of input information (ROW window) and a window for holding an amount of input information falling within a range of the last n days, n hours, n minutes, or n seconds (RANGE window).

The use of those windows (e.g., use of the ROW window) enables aggregation and analysis of n most recent pieces of input information at a time close to the real time with respect to an arbitrary time.

The sliding window absent in the conventional database processing system is an operator unique to the stream data processing system, and is enabled by introducing the CQL.

### SUMMARY OF THE INVENTION

In the stream data processing, unboundedly arriving data is processed in time series. Time information (timestamps) to be assigned to the data may be assigned by the stream data processing system at the time of data arrival or by a data transmission source. For example, in the case of data that needs to be processed in real time such as traffic information or stock price information, the stream data processing system assigns time information at the time of data arrival. On the other hand, when batch processing is performed as in the case of log information, a data input source (data transmission source) assigns time information. The stream data processing system sequentially performs processing according to the timestamps thus assigned to the stream data.

When the times of the data input source (data transmission source) are assigned to timestamps as in the case of batch processing, a plurality of kinds of data completely different from one another in date and time or time point may be input to the stream data processing system simultaneously.

As described above, the stream data processing system has a problem in that only one kind of data can be processed each due to the processing performed in order of the timestamps.

An object of this invention is to enable a stream data processing system to simultaneously process a plurality of kinds of data different from one another in date and time or time point.

A representative aspect of this invention is as follows. That is, A stream data processing method to be used in a stream data processing apparatus that receives stream data including time information and executes processing according to a query registered in advance, the stream data processing apparatus comprising: a stream data reception module for receiving a plurality of pieces of input information including a plurality of pieces of the stream data; a time information analysis module for analyzing the time information on the plurality of pieces of input information for each of the plurality of pieces of input information; a time information adjustment module for generating a plurality of pieces of new input information based on an analysis result of the time information analysis module; and a stream data processing module for executing the processing according to the query for each of the plurality of pieces of new input information, the steam data processing method comprising: a first step of extracting, by the time information analysis module, for the each of the plurality of pieces of input information, the plurality of pieces of the stream data included in the each of the plurality of pieces of input information, and calculating an input interval of the plurality of pieces of the stream data and a first reference time that is a processing time of the plurality of pieces of the stream data; a second step of calculating, by the time information adjustment module, a second reference time that is a new processing time of the plurality of pieces of input information based on the first reference time and the input interval calculated for the each of the plurality of pieces of input information; and a third step of generating, by the time information adjustment module, stream data having new time information assigned thereto for the each of the plurality of pieces of input information based on the second reference time.

According to this invention, there is provided an effect that processing efficiency (memory use amount or calculation amount) in the stream data processing can be enhanced.

Further, there is provided another effect that a manipulation of time information for stream data is made unnecessary, to thereby simplify the operation of the stream data processing apparatus.

### BRIEF DESCRIPTION OF THE DRAWINGS

The present invention can be appreciated by the description which follows in conjunction with the following figures, wherein:

FIG. 1 is a block diagram illustrating a configuration example of a stream data processing system according to a first embodiment of this invention;

FIG. 2 is an explanatory diagram illustrating a flow of processing performed by an input data analysis module and a stream data processing module of the first embodiment;

FIG. 3 is an explanatory diagram illustrating examples of stream definitions for input information and query definitions in the stream data processing system of the first embodiment;

FIG. 4 is an explanatory diagram illustrating examples of an input information 1 and a sampling data 1 of the first embodiment;

FIG. 5 is an explanatory diagram illustrating examples of an input information 2 and a sampling data 2 of the first embodiment of this invention;

FIG. 6 is an explanatory diagram illustrating examples of the sampling data 1, the sampling data 2, and a reference time of the first embodiment;

FIG. 7 is an explanatory diagram illustrating examples of stream data 1 and stream data 2 to which new timestamps are assigned according to the first embodiment;

FIG. 8 is an explanatory diagram illustrating a processing order of the stream data processing system based on the newly assigned timestamp according to the first embodiment;

FIG. 9 is a flowchart illustrating processing of the input data analysis module according to the first embodiment;

FIG. 10 is a flowchart illustrating processing executed by a timestamp adjustment module according to the first embodiment;

FIG. 11 is a block diagram illustrating a configuration example of a stream data processing computer of the second embodiment;

FIG. 12 is an explanatory diagram illustrating examples of a timestamp definition management table and a reference time according to the second embodiment;

FIG. 13 is an explanatory diagram illustrating examples of stream data 1, stream data 2, and stream data 3 to which new timestamps are assigned according to the second embodiment; and

FIG. 14 is a flowchart illustrating processing executed by the timestamp adjustment module of the second embodiment.

### DETAILED DESCRIPTION OF THE PREFERRED EMBODIMENTS

### First Embodiment

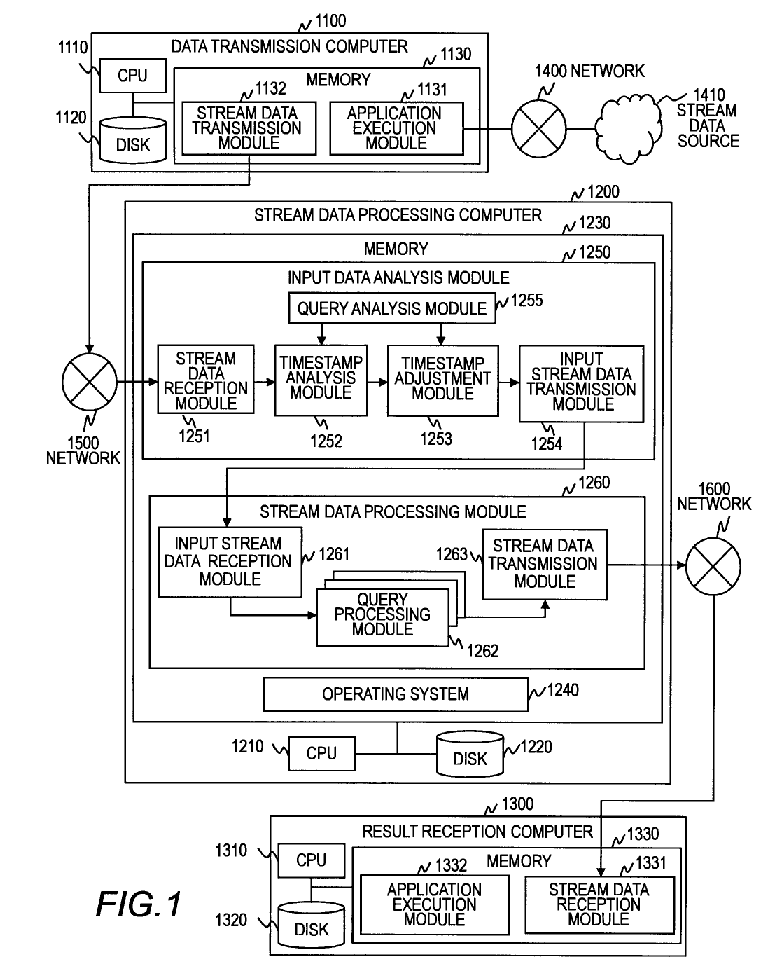

FIG. 1 is a block diagram illustrating a configuration example of a stream data processing system according to a first embodiment of this invention.

The stream data processing system of the first embodiment of this invention includes a data transmission computer 1100, a stream data processing computer 1200, and a result reception computer 1300.

The data transmission computer 1100 and the stream data processing computer 1200 are interconnected via a network 1500, and the result reception computer 1300 and the stream data processing computer 1200 are interconnected via a network 1600. The data transmission computer 1100 is connected to a stream data source 1410 via a network 1400.

The data transmission computer 1100, the stream data processing computer 1200, and the result reception computer 1300 may be mounted on a single casing, or any two of those computers may be combined to be mounted on a single casing. Functions of the computers may be combined to be implemented on one or more casings.

The data transmission computer 1100 generates stream data to be transmitted to the stream data processing computer 1200, and transmits the generated stream data to the stream data processing computer 1200.

The generation processing and the transmission processing for the stream data may be implemented by a program of the data transmission computer 1100 or by dedicated hardware.

The first embodiment is described by taking an example where a transmission application is executed on the data transmission computer 1100.

The data transmission computer 1100 includes a CPU 1110, a DISK 1120, and a memory 1130.

The CPU 1110 executes a program loaded on the memory 1130.

The DISK 1120 stores data used by the program loaded on the memory 1130.

The memory 1130 stores the program executed by the CPU 1110 and data necessary to execute the program. The memory 1130 includes an application execution module 1131 and a stream data transmission module 1132.

The CPU 1110 executes the program loaded on the memory 1130, and thereby stream data is transmitted from the stream data transmission module 1132 to the stream data processing computer 1200 via the network 1500.

The generated stream data may be, for example, data generated by using data read from the DISK 1120 or data acquired from the stream data source 1410 via the network 1400.

Different stream data is generated from a different input source. The different input source may conceivably be a case where a file read from the DISK 1120 is different or a case where information acquired from the stream data source 1410 is from a different computer.

Hereinafter, stream data generated by the data transmission computer 1100 is referred to as input information.

The stream data processing computer 1200 performs various kinds of processing based on received input information. The stream data processing computer 1200 includes a CPU 1210, a DISK 1220, and a memory 1230. The stream data processing computer 1200 may be a computer system such as a blade type computer system or a PC server.

The CPU 1210 executes a program loaded on the memory 1230.

The DISK 1220 stores data used by the program on the memory 1230.

The memory 1230 stores the program executed by the CPU 1210 and data necessary to execute the program. The memory 1230 includes an operating system 1240, and an input data analysis module 1250 and a stream data processing module 1260 that are programs operated on the operating system 1240.

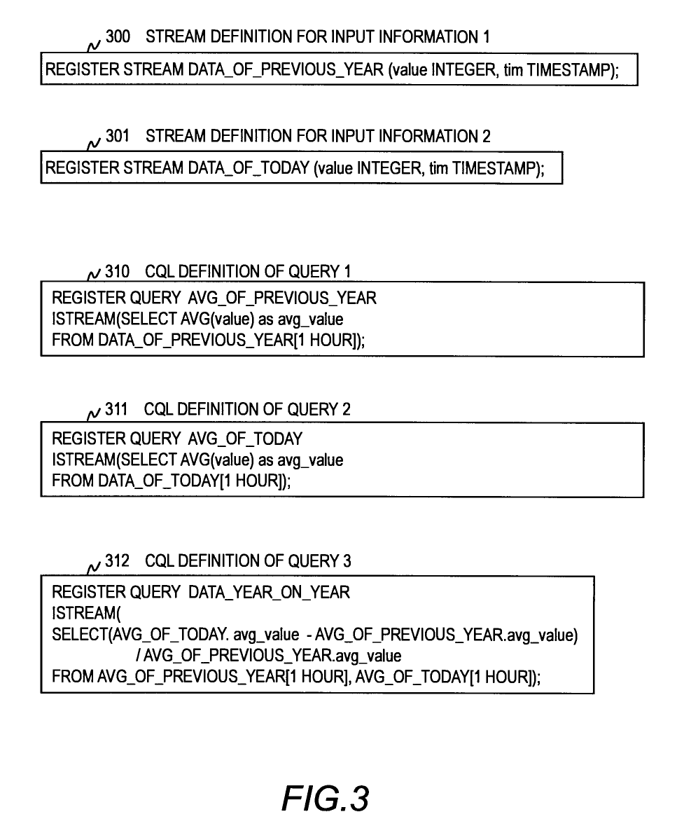

The memory 1230 stores definition information of a query (not shown) to be executed, a query scenario (not shown), and definition information of a stream (not shown) that is information for providing a function of inputting or outputting input information. The definition information of the query (not shown) and the definition information of the stream (not shown) are described later in detail referring to FIG. 3.

The memory 1230 stores a function (not shown) of managing time in the stream data processing system. This function enables the stream data processing computer 1200 to recognize the time in the stream data processing system. This function may be included in another component such as a timestamp adjustment module 1253.

The input data analysis module 1250 analyzes received input information. The input data analysis module 1250 includes a stream data reception module 1251, a timestamp analysis module 1252, the timestamp adjustment module 1253, an input stream data transmission module 1254, and a query analysis module 1255.

The stream data reception module 1251 receives input information from the stream data transmission module 1132 of the data transmission computer 1100 via the network 1500. There may be provided a plurality of the stream data reception modules 1251. In this case, each stream data reception module 1251 can simultaneously receive a plurality of pieces of input information.

The timestamp analysis module 1252 analyzes information regarding a timestamp of the input information based on the timestamp assigned to the input information received by the stream data reception module 1251 and an analysis result transmitted from the query analysis module 1255.

The timestamp adjustment module 1253 generates a new timestamp based on the analysis results of the timestamp analysis module 1252 and the query analysis module 1255, and assigns the generated timestamp to stream data to be input to the stream data processing module 1260.

Hereinafter, the stream data transmitted to the stream data processing module 1260 is referred to as input stream data.

The input stream data transmission module 1254 transmits the input stream data to which the new timestamp generated by the timestamp adjustment module 1253 has been assigned to the stream data processing module 1260.

The query analysis module 1255 analyzes a time range for processing the input information based on the query scenario stored in the memory 1230. In other words, the query analysis module 1255 analyzes a time range that defines a processing target. The query analysis module 1255 analyzes the query scenario to hold a result of the analysis.

The stream data processing module 1260 executes processing for the input stream data. The stream data processing module 1260 includes an input stream data reception module 1261, a query processing module 1262, and a stream data transmission module 1263.

The input stream data reception module 1261 receives the input stream data transmitted from the input stream data transmission module 1254 of the input data analysis module 1250.

The query processing module 1262 aggregates and analyzes the input stream data received by the input stream data reception module 1261 according to the query scenario stored in the memory 1230.

The stream data transmission module 1263 transmits a processing result of the query processing module 1262 to the result reception computer 1300 via the network 1600.

The result reception computer 1300 receives stream data that is the processing result of the stream data processing computer 1200, and executes various kinds of predetermined processing by using the received stream data. The reception processing for the stream data and the predetermined processing may be implemented by a program of the result reception computer 1300 or by dedicated hardware.

The result reception computer 1300 includes a CPU 1310, a DISK 1320, and a memory 1330. In this embodiment, an example where a reception application is executed on the result reception computer 1300 is described.

The CPU 1310 executes a program loaded on the memory 1330.

The disk 1320 stores data used by the program loaded on the memory 1330.

The memory 1330 stores the program executed by the CPU 1310 and data necessary to execute the program. The memory 1330 includes a stream data reception module 1331 and an application execution module 1332.

The CPU 1310 executes the program loaded on the memory 1330. Therefore, the stream data reception module 1331 receives stream data from the stream data transmission module 1263 of the stream data processing computer 1200 via the network 1600, and the application execution module 1332 executes predetermined processing by using the received stream data.

The predetermined processing is, for example, storage of data in an external storage device (not shown) or displaying of data on a display device (not shown).

The network 1400, the network 1500, and the network 1600 may be local area networks (LANs) connected by the Ethernet (registered trademark) or an optical fiber, or wide area networks (WANs) slower than LAN and including the Internet.

An example of the stream data may conceivably be stock price distribution information for a financial application, POS data for retailing, probe car information for a traffic information system, or an error log for computer system management.

Next, a specific processing procedure of the function of the first embodiment is described.

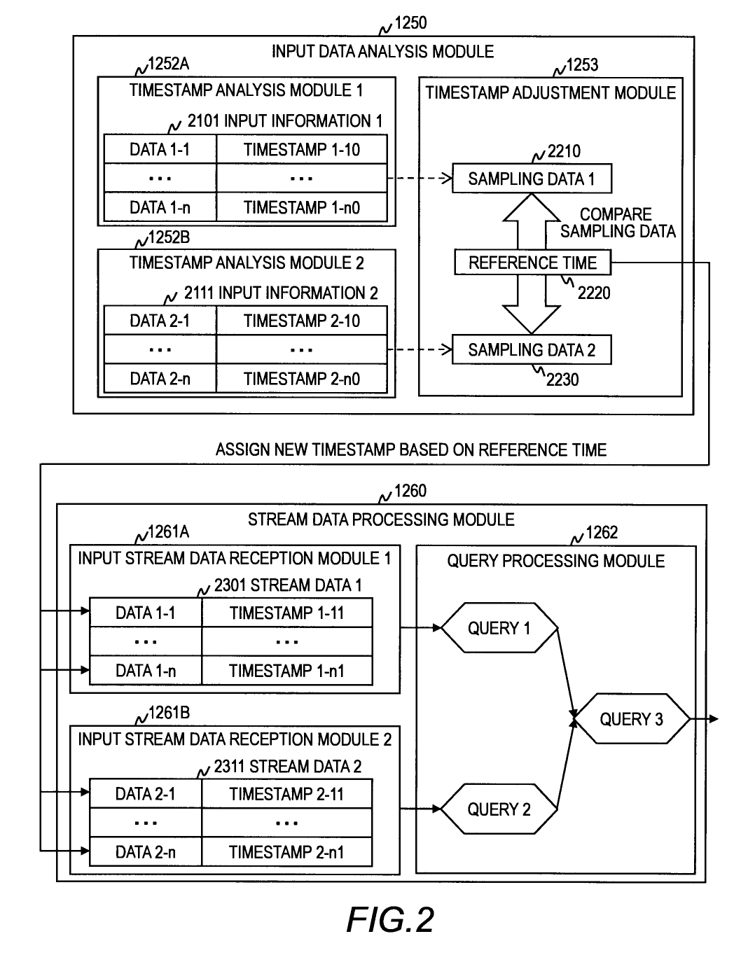

FIG. 2 is an explanatory diagram illustrating a flow of processing performed by the input data analysis module 1250 and the stream data processing module 1260 of the first embodiment.

In the example of FIG. 2, a timestamp analysis module 1 (1252A) holds input information 1 (2101), and a timestamp analysis module 2 (1252B) holds input information 2 (2111).

The input information 1 (2101) and the input information 2 (2111) are n (n is an integer) pieces of stream data each including data and a timestamp.

The timestamp adjustment module 1253 calculates sampling data 1 (2210) by using n timestamps included in the input information 1 (2101) held by the timestamp analysis module 1 (1252A), and calculates sampling data 2 (2230) by using n timestamps included in the input information 2 (2111) held by the timestamp analysis module 2 (1252B).

The timestamp adjustment module 1253 compares the sampling data 1 (2210) with the sampling data 2 (2230), and calculates a reference time (2220) based on a result of the comparison.

The timestamp adjustment module 1253 assigns, based on the calculated reference time, new timestamps to the input information to generate stream data 1 (2301) and stream data 2 (2311). The timestamp adjustment module 1253 transmits the generated stream data 1 (2301) to an input stream data reception module 1 (1261A), and the generated stream data 2 (2311) to an input stream data reception module 2 (1261B).

The query processing module 1262 analyzes and aggregates the input stream data received by the input stream data reception module 1 (1261A) and the input stream data reception module 2 (1261B).

Next, input information and an analysis scenario of this embodiment are specifically described.

This embodiment is described by taking an example where an average values are calculated among pieces of stream data of every one hour based on log information of a previous year and log information of today, and a year-on-year ratio of the average values on the same day and in the same time zone is calculated.

FIG. 3 is an explanatory diagram illustrating examples of stream definitions for input information and query definitions in the stream data processing system of the first embodiment.

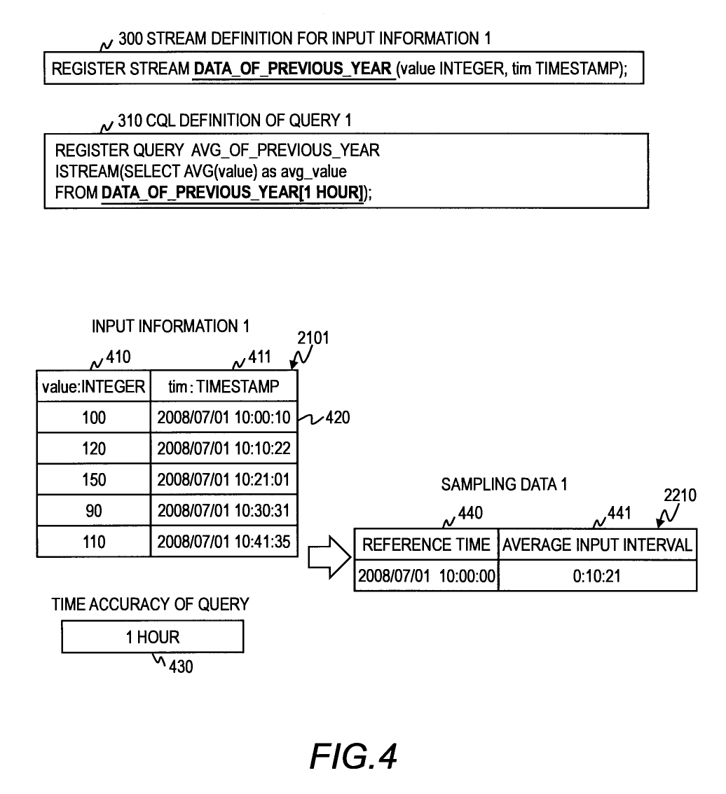

A stream definition 300 for the input information 1 indicates that stream data having data and a timestamp of a previous year is defined as “DATA_OF_PREVIOUS_YEAR”. A specific example of the input information 1 (2101) is described later referring to FIG. 4.

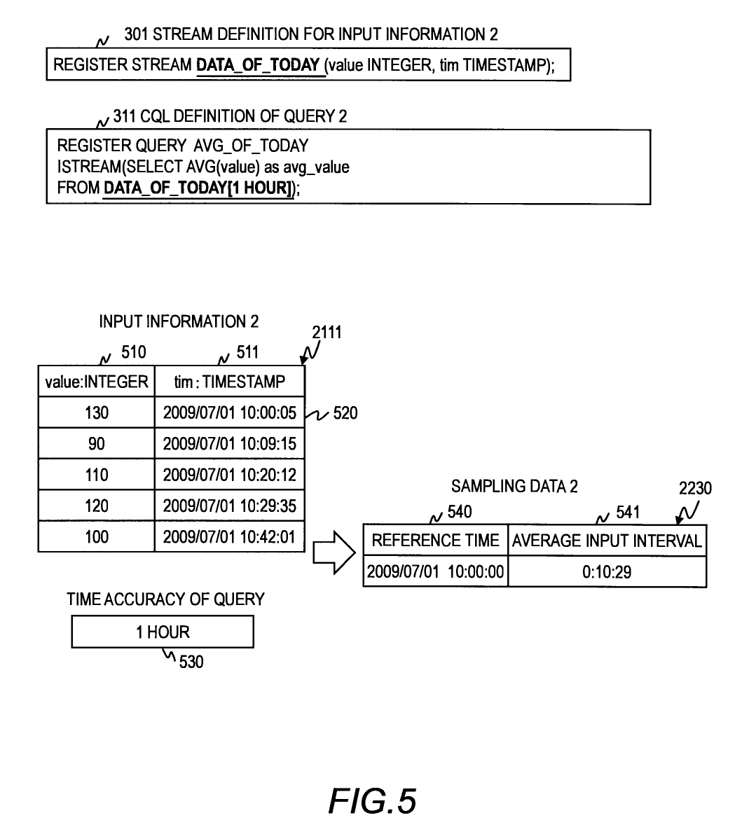

A stream definition 301 for the input information 2 indicates that stream data having data and a timestamp of today is defined as “DATA_OF_TODAY”. A specific example of the input information 2 (2111) is described later referring to FIG. 5.

A CQL definition 310 of a query 1 indicates that a scenario of calculating an average value among piece of stream data of every one hour with respect to the input information of the previous year is defined as a query “AVG_OF_PREVIOUS_YEAR”. A specific processing example of the query is described later referring to FIG. 4.

A CQL definition 311 of a query 2 indicates that a scenario of calculating an average value among piece of stream data of every one hour with respect to the input information of today is defined as a query “AVG_OF_TODAY”. A specific processing example of the query is described later referring to FIG. 5.

A CQL definition 312 of a query 3 indicates that a scenario of joining the query 1 and the query 2 and calculating a year-on-year ratio of target data in a relevant time zone (predetermined time zone) based on the average value of the pieces of stream data of the previous year acquired from the query 1 and the average value of the pieces of stream data of today acquired from the query 2 is defined as a query “DATA_YEAR_ON_YEAR”.

FIG. 4 is an explanatory diagram illustrating examples of the input information 1 (2101) and the sampling data 1 (2210) of the first embodiment.

The input information 1 (2101) includes the data and the timestamp of the previous year defined by the stream definition 300 for the input information 1.

In the input information 1 (2101), a first column 410 indicates a value stored in an INTEGER type schema value of the stream definition 300 for the input information 1, and a second column 411 indicates a value stored in a TIMESTAMP type schema tim of the stream definition 300 for the input information 1.

Hereinafter, the first column 410 is referred to as data 410, and the second column 411 is referred to as a timestamp 411.

In the example of FIG. 4, input data 420 included in the input information 1 (2101) indicates that the data 410 is “100” and the timestamp 411 is “2008, Jul. 1 10:00:10”. In the first embodiment, the timestamp 411 stores a value assigned by a client device (not shown) other than the stream data processing computer 1200.

The CQL definition 310 of the query 1 indicates a query of determining an average value among amounts of input stream data in the input information 1 (2101) that fall within a range of one hour.

“DATA_OF PREVIOUS_YEAR [1 HOUR]” designated in a FROM clause indicates that a stream defined by the stream definition 300 for the input information 1 is input data and an amount of stream data that falls within a range of one hour is a processing target. An average value of the data 410 of the input information 1 is calculated by using an AVG function designated in a SELECT clause.

Time accuracy 430 of a query is information regarding a time window designated by the CQL definition 310 of the query 1. In the example of FIG. 4, information of a time window is [1 HOUR], and hence the time accuracy 430 of the query is [1 HOUR]. In other words, in the query 1, an amount of stream data that falls within a range of one hour is a processing target.

The sampling data 1 (2210) includes a reference time 440 and an average input interval 441.

The reference time 440 is a value determined by rounding down values equal to or less than the time accuracy 430 of the query for time indicated by the timestamp 411 of the input data 400 that is head data of the sampling data 1 (2210). In other words, the reference time 440 indicates a time of a processing target in the input information. Based on the time indicated by the reference time 440, stream data at a time interval indicated by the time accuracy 430 of the query is stream data of a processing target.

In the example of FIG. 4, the time accuracy 430 of the query is [1 HOUR], and hence values smaller than “HOUR” of the timestamp “2008, Jul. 1 10:00:10” of the input data 420, in other words, “MINUTE” and “SECOND”, are rounded down to obtain a time “2008, Jul. 1 10:00:00”, which is set as the reference time 440. When the time accuracy 430 of the query is “n MINUTE (n is a natural number)” or “n SECOND (n is a natural number)”, in this example, the reference time of the input data 420 is set to “2008, Jul. 1 10:00:00” or “2008, Jul. 1 10:00:10”.

The average input interval 441 is an average value of time intervals at which stream data is input. Specifically, the average input interval 441 is an average value of input intervals calculated based on the timestamp 411.

FIG. 5 is an explanatory diagram illustrating examples of the input information 2 (2111) and the sampling data 2 (2230) of the first embodiment of this invention.

The input information 2 (2111) includes the data and the timestamp of today defined by the stream definition 301 for the input information 2.

In the input information 2 (2111), a first column 510 indicates a value stored in an INTEGER type schema value of the stream definition 301 for the input information 2, and a second column 511 indicates a value stored in a TIMESTAMP type schema tim of the stream definition 301 for the input information 2.

Hereinafter, the first column 510 is referred to as data 510, and the second column 511 is referred to as a timestamp 511.

In the example of FIG. 5, input data 520 included in the input information 2 (2111) indicates that the data 510 is “130” and the timestamp 511 is “2009, Jul. 1 10:00:05”. In this embodiment, the timestamp 511 stores a value assigned by a client device (not shown) other than the stream data processing computer 1200.

The CQL definition 311 of the query 2 indicates a query of determining an average value among amounts of input stream data in the input information 2 (2111) that falls within a range of one hour.

“DATA_OF_TODAY [1 HOUR]” designated in a FROM clause indicates that a stream defined by the stream definition 301 for the input information 2 is input data and an amount of stream data that falls within a range of one hour is a processing target. An average value of the data 510 of the input information 2 is calculated by using an AVG function designated in a SELECT clause.

Time accuracy 530 of a query is information regarding a time window designated by the CQL definition 311 of the query 2. In the example of FIG. 5, information of a time window is [1 HOUR], and hence the time accuracy 530 of the query is [1 HOUR]. In other words, in the query 2, an amount of stream data that falls within a range of one hour is a processing target.

The sampling data 2 (2230) includes a reference time 540 and an average input interval 541.

The reference time 540 is a value determined by rounding down values equal to or less than the time accuracy 530 of the query for time indicated by the timestamp 511 of the input data 520 that is head data of the sampling data 2 (2230). In other words, the reference time 540 indicates a time of a processing target in the input information. Based on the time indicated by the reference time 540, stream data at a time interval indicated by the time accuracy 530 of the query is stream data of a processing target.

In the example of FIG. 5, the time accuracy 530 of the query is [1 HOUR], and hence values smaller than “HOUR” of the timestamp “2009, Jul. 1 10:00:05” of the input data 520, in other words, “MINUTE” and “SECOND”, are rounded down to obtain a time “2009, Jul. 1 10:00:00”, which is set as the reference time 540.

The average input interval 541 is an average value of time intervals at which stream data is input. Specifically, the average input interval 541 is an average value of input intervals calculated based on the timestamp 511.

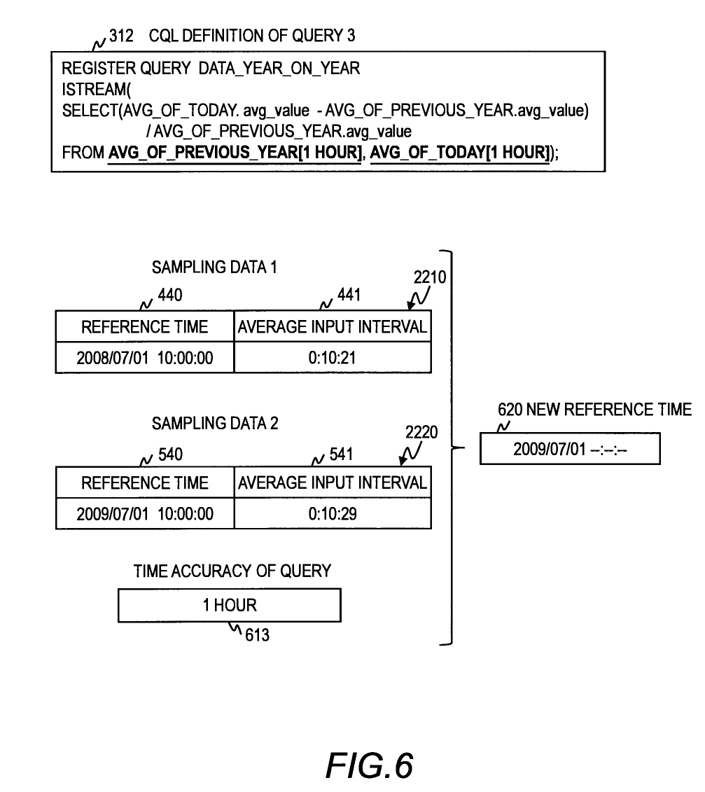

FIG. 6 is an explanatory diagram illustrating examples of the sampling data 1 (2210), the sampling data 2 (2230), and a reference time of the first embodiment.

The CQL definition 312 of the query 3 indicates a query of determining a year-on-year ratio of average values in a relevant time zone based on an average value of the data 410 of the previous year determined by the CQL definition 310 of the query 1 and an average value of the data 510 of today determined by the CQL definition 311 of the query 2.

“AVG_OF_PREVIOUS_YEAR [1 HOUR]” and “AVG_OF_TODAY [1 HOUR]” designated in the FROM clause indicate that a result of the CQL definition 310 of the query 1 and a result of the CQL definition 311 of the query 2 are inputs and amounts of stream data that fall within a range of one hour are processing targets. A computational expression designated in the SELECT clause indicates an expression for calculating a ratio of average values.

The sampling data 1 (2210) and the sampling data 2 (2230) are similar to those illustrated in FIG. 4 and FIG. 5.

Time accuracy 613 of a query indicates that in the CQL definition 312 of the query 3, a designated value of a time window is “HOUR”, and hence in the query 3 processing is executed by an “HOUR” unit.

In a case of a value “2008, Jul. 1 10:00:00” of the reference time 440 in the sampling data 1 (2210) is compared with a value “2009, Jul. 1 10:00:00” of the reference time 540 in the sample data 2 (2230), the values are similar except for values of “YEAR”.

The average time interval 441 in the sampling data 1 (2210) is “0:10:21”, and the average input interval 541 in the sampling data 2 (2230) is “0:10:29”. Thus, the input intervals of both pieces of sampling data are in order of “MINUTE”.

From the foregoing, the input information 1 (2101) and the input information 2 (2111) are judged to be data of the same time zone where only “YEAR” of the timestamps is different. In other words, those two kinds of processing are judged to be simultaneously executable.

A new reference time 620 is a time for calculating new timestamps to be set in the simultaneously processed data. In this embodiment, the latest time among reference times of all pieces of sampling data is set.

In the example of FIG. 6, in the reference time 620, “YEAR”, “MONTH”, and “DAY” larger than “HOUR” of the time accuracy 613 of the query are set to “2009, Jul. 1”. “HOUR”, “MINUTE”, and “SECOND” equal to or less than the time accuracy 613 of the query of the reference time 620 are not timestamp adjustment targets, and hence set to “--:--:--”.

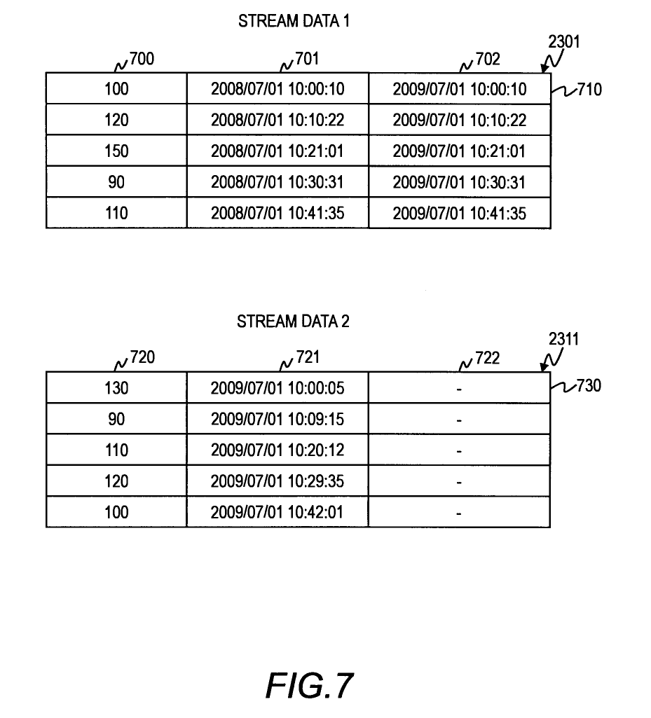

FIG. 7 is an explanatory diagram illustrating examples of stream data 1 (2301) and stream data 2 (2311) to which new timestamps are assigned according to the first embodiment.

A first column 700 of the stream data 1 (2301) is a value stored in an INTEGER type schema value.

A second column 701 of the stream data 1 (2301) stores a value assigned by a client device (not shown) other than the steam data processing computer 1200. Specifically, a value equal to the value of the timestamp 411 is stored.

A third column 702 of the stream data 1 (2301) is a newly assigned timestamp. Specifically, the third column 702 is a new timestamp generated based on the reference time 620 “2009, Jul. 1” calculated in FIG. 6.

Hereinafter, the first column 700 is referred to as data 700, the second column 701 is referred to as a timestamp 701, and the third column 702 is referred to as a new timestamp 702.

In the example of FIG. 7, in the new timestamp 702, the new reference time 620 “2009, Jul. 1” is set with respect to “YEAR”, “MONTH”, and “DAY” of the timestamp 701, and values of the original timestamp 701 are directly set for values of “HOUR”, “MINUTE” and “SECOND”.

In the stream data 2 (2311), the reference time 620 “2009, Jul. 1” calculated in FIG. 6 and the reference time 540 of the sampling data 2 (2230) are similar to each other, and hence no new timestamp is set. Thus, a first column 720 of the stream data 2 (2311) stores the data 510 of the input information 2 (2111), and a second column 721 stores the timestamp 511 of the input information 2 (2111). A third column 722 stores no data.

Hereinafter, the first column 720 is referred to as data 720, the second column 721 is referred to as a timestamp 721, and the third column 722 is referred to as a new timestamp 722.

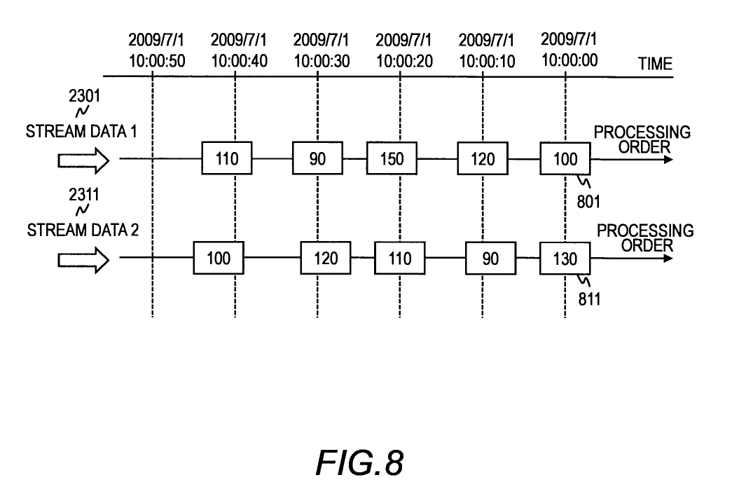

FIG. 8 is an explanatory diagram illustrating a processing order of the stream data processing system based on the newly assigned timestamp according to the first embodiment.

Stream data 801 indicates the data 700 of the stream data 1 (2301) of FIG. 7.

Stream data 811 indicates the data 720 of the stream data 2 (2311) of FIG. 7.

Stream data 1 (800) and stream data 2 (810) are stream data where values of “YEAR” of the timestamp are different between the input information 1 (2101) and the input information 2 (2111) when input, in other words, stream data where timestamps are different. However, as illustrated in FIG. 8, new timestamps are assigned, and thereby the pieces of stream data are simultaneously processed as pieces of stream data of the same time zone.

Next, a processing flow of this embodiment is described.

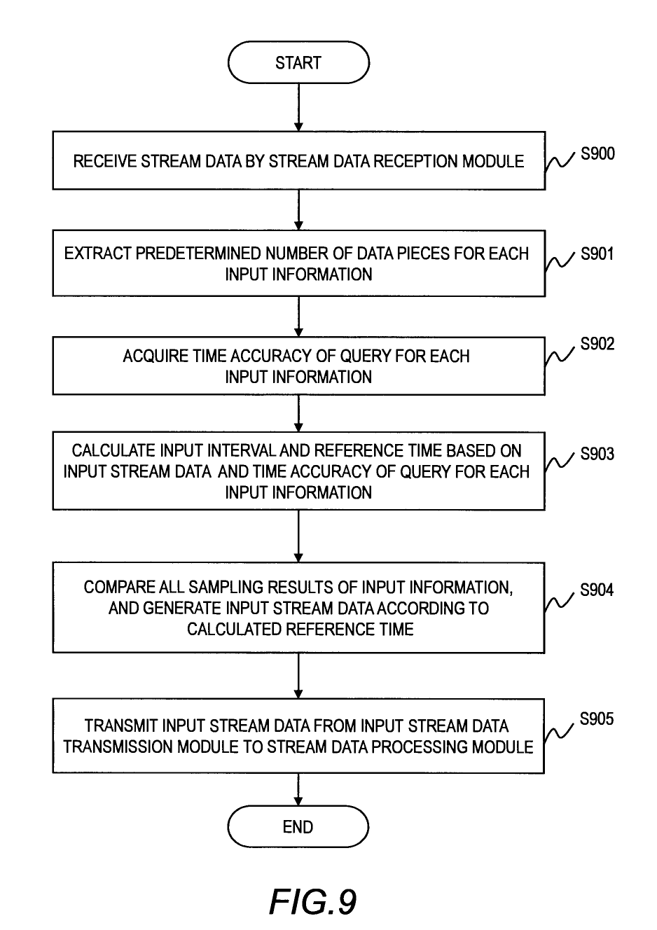

FIG. 9 is a flowchart illustrating processing of the input data analysis module 1250 according to the first embodiment.

First, in Step S900, the stream data reception module 1251 receives two or more pieces of input information from the data transmission computer 1100.

In Step S901, the timestamp analysis module 1252 extracts a predetermined number of pieces of stream data for each received input information. The number of pieces of stream data to be extracted can be determined by referring to the stream definition and the CQL definition of a query. The extracted pieces of stream data are transmitted to the timestamp adjustment module 1253.

In Step S902, the query analysis module 1255 acquires time accuracy of a query for each received input information by referring to the stream definition and the CQL definition of the query. The acquired time accuracy of the query is transmitted to the timestamp adjustment module 1253.

In Step S903, the timestamp adjustment module 1253 calculates sampling data for each input information based on the input stream data and the time accuracy of the query. In other words, the timestamp adjustment module 1253 calculates an input interval and a reference time (corresponding to “first reference time”).

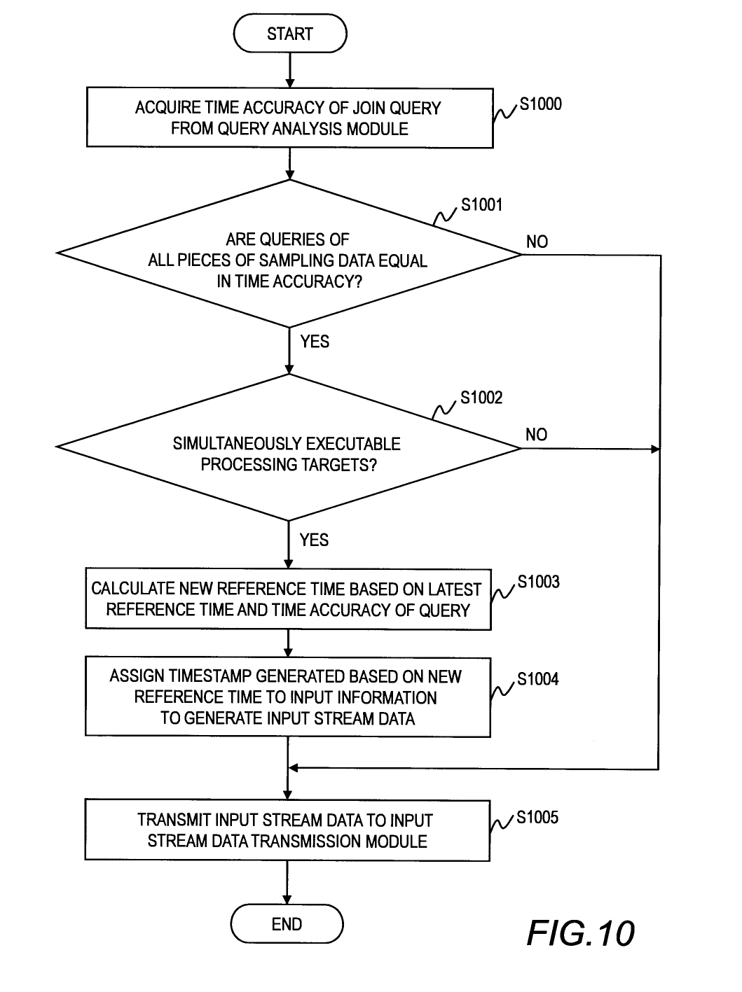

In Step S904, the timestamp adjustment module 1253 compares all pieces of calculated sampling data to calculate a new reference time (corresponding to “second reference time”), and generates input stream data to which a new timestamp has been assigned based on the calculated new reference time. The processing of Step S904 is described later in detail referring to FIG. 10. The generated input stream data is transmitted to the input stream data transmission module 1254.

In Step S905, the input stream data transmission module 1254 transmits the received input stream data to the stream data processing module 1260.

Through this processing, the stream data processing module 1260 can simultaneously execute a plurality of kinds of processing based on the new timestamp assigned to the input stream data.

FIG. 10 is a flowchart illustrating processing executed by the timestamp adjustment module 1253 according to the first embodiment.

In Step S1000, the timestamp adjustment module 1253 acquires time accuracy of a join query from the query analysis module 1255. The join query refers to a query for executing processing based on input results of a plurality of queries. For example, in FIG. 2, the query 3 is a join query.

The timestamp adjustment module 1253 can recognize the join query by acquiring an analysis result of the query analysis module 1255. Processing below is executed for each join query.

In Step S1001, the timestamp adjustment module 1253 judges whether queries of all pieces of sampling data for the input information input to the join query are equal in time accuracy.

If it is judged that the queries of all pieces of sampling data for the input information input to the join query are not equal in time accuracy, the timestamp adjustment module 1253 proceeds to Step S1005.

If it is judged that the queries of all pieces of sampling data for the input information input to the join query are equal in time accuracy, in Step S1002, the timestamp adjustment module 1253 judges whether the pieces of input information input to the join query are simultaneously executable processing targets.

Specifically, the following two kinds of judgment processing are executed. Any of those kinds of judgment processing can be executed first.

In the first judgment processing, the timestamp adjustment module 1253 judges whether all pieces of sampling data for the input information are equal in average input interval.

In this judgment, it is judged whether average input intervals of all pieces of sampling data are within a range of an error in a case of a time indicated in time accuracy of a query is set as the range of the error.

If the average input intervals of all pieces of sampling data are within the range of the error, it is judged that all pieces of sampling data for the input information are equal in average input interval. On the other hand, if the average input intervals of all pieces of sampling data are not within the range of the error, it is judged that all pieces of sampling data for the input information are unequal in average input interval.

For example, when time accuracy of a query is “1 HOUR”, sampling data of an average input interval of “0:10:00” and sampling data of an average input interval of “0:20:00” are included within one hour of an error. Hence, it is judged that those pieces of sampling data are equal in average input interval.

In the second judgment processing, the timestamp adjustment module 1253 judges whether pieces of reference times of pieces of sampling data are equal in value equal to or less than the time indicated by time accuracy of a query.

For example, when time accuracy of a query is “1 HOUR”, sampling data of a reference time of “2008, Jul. 1 10:00:00” and sampling data of a reference time of “2009, Jul. 1 10:00:00” are equal in value equal to or less than “HOUR”, and hence judged to be equal in value equal to or less than the time indicated by the time accuracy of the query.

If both of the first judgment processing and the second judgment processing are satisfied, it is judged that pieces of input information input to the join query are simultaneously executable processing targets.

If at least one of the first judgment processing and the second judgment processing is not satisfied, it is judged that the pieces of input information input to the join query are not simultaneously executable processing targets.

In a case of it is judged that the pieces of input information input to the join query are not simultaneously executable processing targets, the timestamp adjustment module 1253 proceeds to Step S1005.

In a case of it is judged that the pieces of input information input to the join query are simultaneously executable processing targets, in Step S1003, the timestamp adjustment module 1253 acquires the latest reference time among the reference times of the pieces of sampling data in the pieces of input information input to the join query, and calculates a new reference time based on the time accuracy of the query and the acquired latest reference time.

Specifically, the timestamp adjustment module 1253 excludes values equal to or less than the time indicated by the time accuracy of the query from adjustment targets, and sets values larger than the time indicated by the time accuracy of the query to the latest reference time among the reference times of the pieces of sampling data, to thereby calculate a new reference time.

For example, in a case of time accuracy of a query is “1 HOUR”, units of “YEAR”, “MONTH”, and “DAY” are timestamp adjustment targets, and “YEAR”, “MONTH”, and “DAY” of the latest reference time are set as a new reference time.

In Step S1004, the timestamp adjustment module 1253 assigns, based on the calculated new reference time, a new timestamp to the input information to generate input stream data.

Specifically, the timestamp adjustment module 1253 compares the new reference time with the reference time of each sampling data, and judges whether all values of the new reference time are equal to values of the time indicated by the reference time of the sampling data. In other words, the timestamp adjustment module 1253 judges whether the values of the time set in the new reference time are equal to the values of the reference time in units corresponding to those of the time in the sampling data.

For example, when “YEAR”, “MONTH”, and “DAY” are set in the new reference time, the timestamp adjustment module 1253 judges whether values of “YEAR”, “MONTH”, and “DAY” of the reference time of the sampling data are all equal to values of “YEAR”, “MONTH”, and “DAY” of the new reference time.

If it is judged that all the values of the time set in the new reference time are equal to the values of the time indicated by the reference time of the sampling data, the timestamp adjustment module 1253 assigns no new timestamp. In this case, input stream data having only an original timestamp assigned thereto is generated.

If it is judged that all the values of the time set in the new reference time are not equal to the values of the time indicated by the reference time of the sampling data, the timestamp adjustment module 1253 assigns a timestamp obtained by overwriting the original timestamp with the new reference time as a new timestamp to the input information to generate input stream data.

In Step S1005, the timestamp adjustment module 1253 transmits the generated input stream data to the input stream data transmission module 1254 to complete the processing.

According to the first embodiment, when it is judged that a plurality of pieces of stream data input to arbitrary queries are simultaneously executable processing targets, the pieces of stream data are simultaneously processed by assigning a new timestamp.

### Second Embodiment

Next, a second embodiment of this invention is described.

The second embodiment of this invention is different from the first embodiment of this invention in that a new reference time is calculated based on adjustment accuracy and an adjustment time of a timestamp defined from the outside. Hereinafter, differences from the first embodiment are mainly described.

A configuration of a stream data processing system of the second embodiment is similar to that of the first embodiment, and thus description thereof is omitted. The second embodiment is different from the first embodiment in configuration of a stream data processing computer 11000.

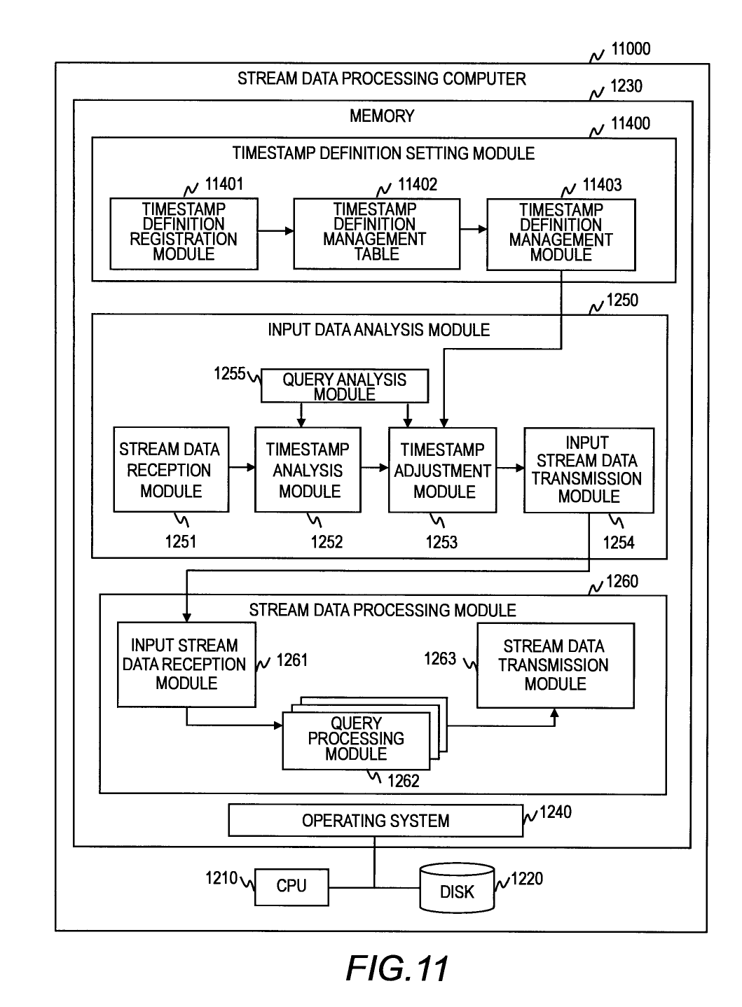

FIG. 11 is a block diagram illustrating a configuration example of the stream data processing computer 11000 of the second embodiment. Components similar to those of FIG. 1 are denoted by similar reference numerals, and description thereof are omitted.

As a difference from FIG. 1, a memory 11300 of the stream data processing computer 11000 includes a timestamp definition setting module 11400.

The timestamp definition setting module 11400 manages definition information regarding a timestamp. The timestamp definition setting module 11400 includes a timestamp definition registration module 11401, a timestamp definition management table 11402, and a timestamp definition management module 11403.

The timestamp definition registration module 11401 receives a definition regarding a timestamp from a user. The definition regarding the timestamp may be received from a user who operates the stream data processing computer 11000 or a user who operates a client device (not shown).

The timestamp definition management table 11402 stores contents of the definition received by the timestamp definition registration module 11401.

The timestamp definition management module 11403 manages the timestamp definition management table 11402, and transmits definition information in response to an acquisition request from the timestamp adjustment module 1253.

Hereinafter, the second embodiment is described about a case where three streams are defined. Input information 1, input information 2, and input information 3 are defined for the streams. Stream data 1 is generated based on the input information 1, stream data 2 is generated based on the input information 2, and stream data 3 is generated based on the input information 3.

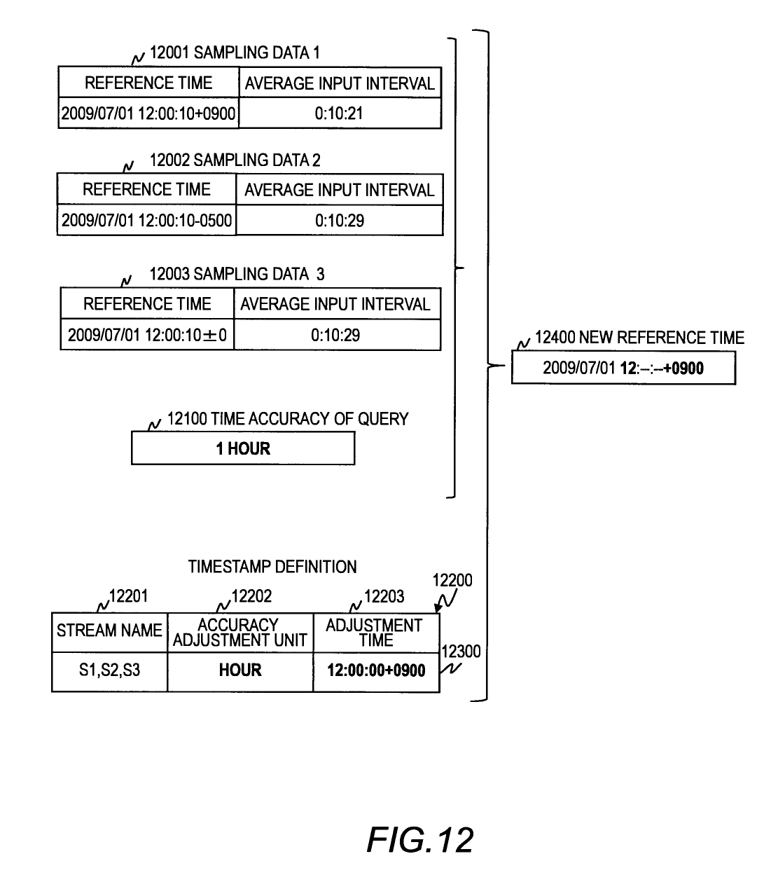

FIG. 12 is an explanatory diagram illustrating examples of the timestamp definition management table 11402 and a reference time according to the second embodiment.

Sampling data 1 (12001), sampling data 2 (12002), and sampling data 3 (12003) each include a reference time and an average input interval calculated based on each input information.

Time accuracy 12100 of a query is time accuracy of a join query of the input information 1, the input information 2, and the input information 3, indicating that processing is performed by a “HOUR” unit from a value “HOUR”.

A timestamp definition 12200 indicates definition contents stored in the timestamp definition management table 11402. The timestamp definition 12200 includes a stream name 12201, an accuracy adjustment unit 12202, and an adjustment time 12203.

The stream name 12201 is an identifier for identifying a stream. The accuracy adjustment unit 12202 indicates a time unit for adjusting a timestamp. The adjustment time 12203 indicates a time for adjusting the timestamp.

In the example of FIG. 12, in definition data 12300 of the timestamp definition 12200, the stream name 12201 stores “S1, S2, S3”, the accuracy adjustment unit 12202 stores “HOUR”, and the adjustment time 12203 stores “12:00:00+0900”.

In other words, in streams whose stream names are “S1, S2, and S3”, a timestamp is adjusted with the accuracy adjustment unit set as “HOUR”, and the adjustment time is set to “12:00:00+0900”.

A new reference time 12400 includes a year/month/day “2009, Jul. 1” determined based on the sampling data 1 (12001), the sampling data 2 (12002), and the sampling data 3 “12003”, and the time accuracy 12100 of the query, and a time “12:--:--+0900” determined based on the timestamp definition 12200.

In the example of FIG. 12, the sampling data 1 (12001), the sampling data 2 (12002), and the sampling data 3 (12003) are timestamp data where time zones are respectively assigned by JST, EST, and GMT. In the new reference time 12400, JST of the same time zone is set in timestamps of different time zones.

The timestamp adjustment module 1253 executes processing based on the new reference time 12400. Processing executed by the other components is similar to that of the first embodiment, and thus description thereof are omitted.

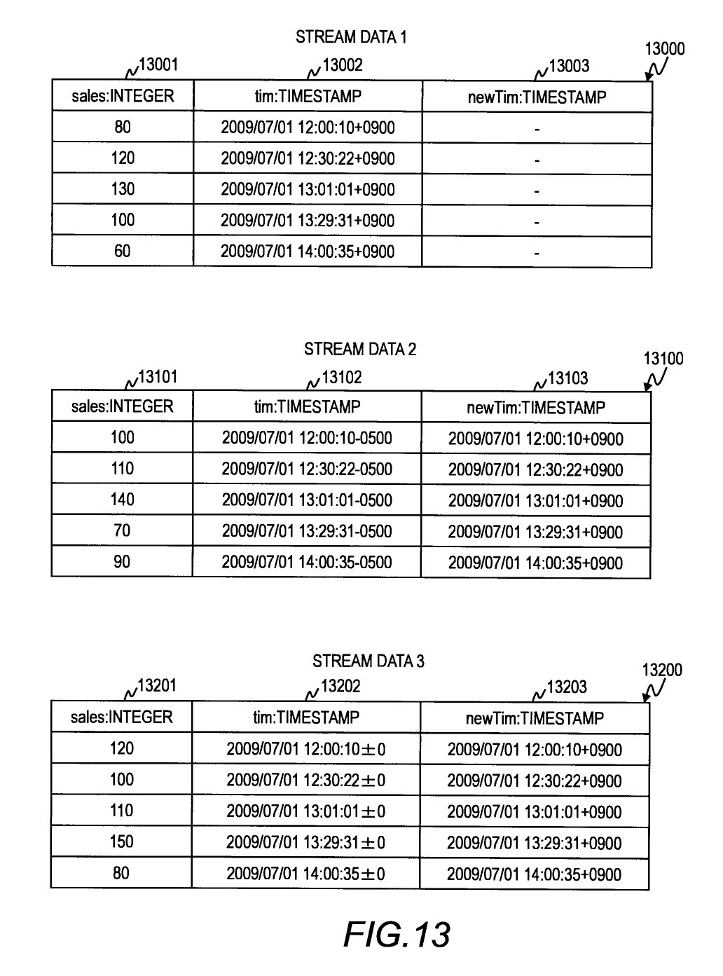

FIG. 13 is an explanatory diagram illustrating examples of stream data 1 (13000), stream data 2 (13100), and stream data 3 (13200) to which new timestamps are assigned according to the second embodiment.

Data 13001 of a first column and a timestamp 13002 of a second column of the stream data 1 (13000) are equal in value to those of the input information 1. A timestamp 13003 of a third column indicates that no timestamp is assigned because the reference time 12400 and the reference time of the sampling data 1 (12001) are the same.

Data 13101 of a first column and a timestamp 13102 of a second column of the stream data 2 (13100) are equal in value to those of the input information 2. A timestamp 13103 of a third column is a new timestamp assigned based on the reference time 12400.

Data 13201 of a first column and a timestamp 13202 of a second column of the stream data 3 (13200) are equal in value to those of the input information 3. A timestamp 13203 of a third column is a new timestamp assigned based on the reference time 12400.

Next, a processing flow of the second embodiment is described.

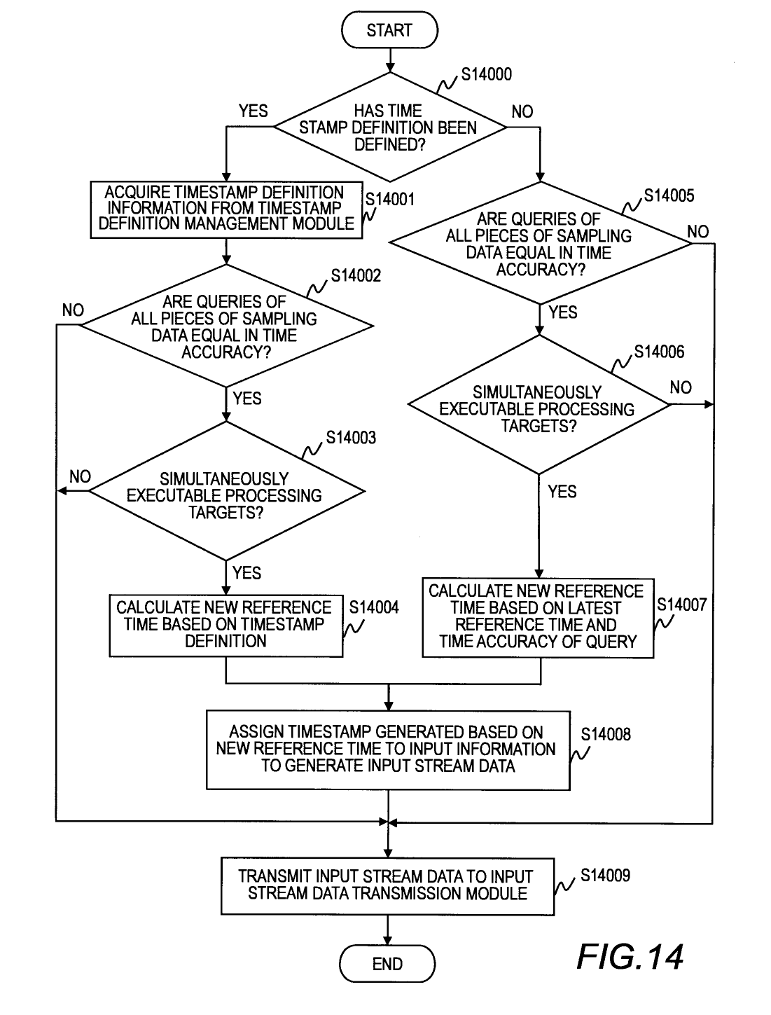

FIG. 14 is a flowchart illustrating processing executed by the timestamp adjustment module 1253 of the second embodiment.

The processing described below is executed for each join query.

In Step S14000, the timestamp adjustment module 1253 judges whether a timestamp definition has been defined.

Specifically, the timestamp adjustment module 1253 can make judgment by making an inquiry to the time stamp definition management module 11403 and receiving a response indicating that a timestamp definition has been defined.

If it is judged that no timestamp definition has been defined, the timestamp adjustment module 1253 executes processing of steps S14005 to S14009. The processing of steps S14005 to S14009 is similar to that of the first embodiment, and thus description thereof is omitted.

If it is judged that a timestamp definition has been defined, in Step S14001, the timestamp adjustment module 1253 acquires a timestamp definition from the timestamp definition management module 11403.

In Step S14002, the timestamp adjustment module 1253 judges whether queries of all pieces of sampling data are equal in time accuracy. For this judgment, the same judgment method as that of Step S1001 is used.

If it is judged that the queries of all the pieces of sampling data are not equal in time accuracy, the timestamp adjustment module 1253 proceeds to Step S14009.

If it is judged that the queries of all the pieces of sampling data are equal in time accuracy, in Step S14003, the timestamp adjustment module 1253 judges whether pieces of input information are simultaneously executable processing targets.

Specifically, the following two kinds of judgment processing are executed. Any of those kinds of judgment processing can be executed first.

In the first judgment processing, the timestamp adjustment module 1253 judges whether all pieces of sampling data for the input information are equal in average input interval. In this judgment, it is judged whether average input intervals of all pieces of sampling data are equal when a time indicated in time accuracy of a query is set as a range of an error.

For example, when time accuracy of a query is “1 HOUR”, sampling data of an average input interval of “0:10:00” and sampling data of an average input interval of “0:20:00” are included within one hour of an error. Hence, it is judged that those pieces of sampling data are equal in average input interval.

In the second judgment processing, the timestamp adjustment module 1253 judges whether reference times of pieces of sampling data are equal in value equal to or less than the time indicated by the accuracy adjustment unit of the timestamp definition.

For example, when the accuracy adjustment unit of the timestamp definition is “HOUR”, sampling data of a reference time of “2008, Jul. 1 12:00:00+0900” and sampling data of a reference time of “2009, Jul. 1 12:00:00−0500” are equal in value of units equal to or less than “HOUR”, and hence judged to be equal in value equal to or less than the time indicated by the accuracy adjustment unit of the timestamp definition.

If it is judged that both of results of the first judgment processing and the second judgment processing are satisfied, it is judged that all pieces of input information are simultaneously executable processing targets.

If at least one of the first judgment processing and the second judgment processing is not satisfied, it is judged that the pieces of input information are not simultaneously executable processing targets.

If it is judged that the pieces of input information are not simultaneously executable processing targets, the timestamp adjustment module 1253 proceeds to Step S14009.

If it is judged that the pieces of input information are simultaneously executable processing targets, in Step S14004, the timestamp adjustment module 1253 calculates a new reference time based on the timestamp definition.

Specifically, the timestamp adjustment module 1253 calculates time information of a unit larger than a time indicated by time accuracy of a query based on the time accuracy of the query and the latest reference time among reference times of the pieces of sampling data.

For example, when time accuracy of a query is “1 HOUR”, information on units of “YEAR”, “MONTH”, and “DAY” is calculated.

The timestamp adjustment module 1253 adjusts a unit indicated by an accuracy adjustment unit of the timestamp definition based on an adjustment time of the timestamp definition.

For example, in the example of FIG. 12, an accuracy adjustment unit of the timestamp definition is “HOUR” and an adjustment time of the timestamp definition is “12:00:00+0900”. Hence, a unit of “HOUR” is adjusted to “12:--:--”, and a time zone is adjusted to JST.

In Step S14008, based on the calculated new reference time, the timestamp adjustment module 1253 assigns a new timestamp to the input information to generate input stream data.

Specifically, the timestamp adjustment module 1253 compares the new reference time with the reference time of each sampling data, and judges whether all values of the time set in the new reference time are equal to values of the time indicated by the reference time of the sampling data.

If it is judged that all the values of the time set in the new reference time are equal to the values of the time indicated by the reference time of the sampling data, the timestamp adjustment module 1253 assigns no new timestamp.

If it is judged that all the values of the time set in the new reference time are not equal to the values of the time indicated by the reference time of the sampling data, the timestamp adjustment module 1253 assigns a timestamp obtained by overwriting the original timestamp with the time set in the new reference time as a new timestamp to the input information. The setting method for the new timestamp is the same as that of the first embodiment, and thus description thereof is omitted.

In Step S14009, the timestamp adjustment module 1253 transmits the generated input stream data to the input stream data transmission module 1254 to complete the processing.

According to the second embodiment, when it is judged that a plurality of pieces of stream data input to arbitrary queries are simultaneously executable processing targets, the pieces of stream data are simultaneously processed by assigning a new timestamp based on the user's setting.

While the present invention has been described in detail and pictorially in the accompanying drawings, the present invention is not limited to such detail but covers various obvious modifications and equivalent arrangements, which fall within the purview of the appended claims.

What is claimed is:

1. A stream data processing method to be used in a stream data processing apparatus that receives stream data including time information and executes processing according to a query registered in advance,
the stream data processing apparatus comprising:
a stream data reception module for receiving a plurality of pieces of input information including a plurality of pieces of the stream data;
a time information analysis module for analyzing the time information on the plurality of pieces of input information for each of the plurality of pieces of input information;
a time information adjustment module for generating a plurality of pieces of new input information based on an analysis result of the time information analysis module; and
a stream data processing module for executing the processing according to the query for each of the plurality of pieces of new input information,
the steam data processing method comprising:
a first step of extracting, by the time information analysis module, for the each of the plurality of pieces of input information, the plurality of pieces of the stream data included in the each of the plurality of pieces of input information, and calculating an input interval of the plurality of pieces of the stream data and a first reference time that is a processing time of the plurality of pieces of the stream data;
a second step of calculating, by the time information adjustment module, a second reference time that is a new processing time of the plurality of pieces of input information based on the input interval and the first reference time calculated for the each of the plurality of pieces of input information; and
a third step of generating, by the time information adjustment module, stream data having new time information assigned thereto for the each of the plurality of pieces of input information based on the second reference time.

2. The stream data processing method according to claim 1, further comprising a fourth step of processing, by the stream data processing module, the plurality of pieces of input information based on the new time information.

3. The stream data processing method according to claim 1, wherein the second step comprises a step of calculating, by the time information adjustment module, the second reference time based on time accuracy defined in the query for executing the processing by using the plurality pieces of the stream data included in the plurality of pieces of input information and indicating a time range of stream data that is a processing target among the plurality of pieces of the stream data, and the time information assigned to the extracted plurality of pieces of stream data.

4. The stream data processing method according to claim 1,
wherein the stream data processing apparatus manages a time of a computer system, and
wherein the second step comprises a step of calculating, by the time information adjustment module, the second reference time by using the first reference time closest to the time of the computer system among the first reference times of the plurality of pieces of input information.

5. The stream data processing method according to claim 1,
wherein the stream data processing apparatus further comprises a time information definition setting module for receiving adjustment accuracy information and adjustment time information that are used for determining the second reference time, and
wherein the second step comprises a step of calculating, by the time information adjustment module, the second reference time based on a comparison result of the input interval and the first reference time among the plurality of pieces of the stream data for the each of the plurality of pieces of input information, the adjustment accuracy information, and the adjustment time information.

6. A recording medium readable by a stream data processing apparatus that receives stream data including time information and executes processing according to a query registered in advance,
the recording medium having a stream data processing program recorded thereon, the stream data processing program controlling the stream data processing apparatus to execute:
a first procedure of receiving a plurality of pieces of input information including a plurality of pieces of the stream data, extracting, for each of the plurality of pieces of input information, the plurality of pieces of the stream data included in the each of the plurality of pieces of input information, and calculating an input interval of the plurality of pieces of the stream data and a first reference time that is a processing time of the plurality of pieces of the stream data;
a second procedure of calculating, based on the input interval and the first reference time calculated for the each of the plurality of pieces of input information, a second reference time that is a new processing time of the plurality of pieces of input information; and
a third procedure of generating, based on the second reference time, stream data having new time information assigned thereto for the each of the plurality of pieces of input information.

7. The recording medium according to claim 6, wherein the stream data processing program further controls the stream data processing apparatus to execute a fourth procedure of processing the plurality of pieces of input information based on the new time information.

8. The recording medium according to claim 6, wherein the second procedure comprises a procedure of calculating the second reference time based on time accuracy defined in the query for executing the processing by using the plurality pieces of the stream data included in the plurality of pieces of input information and indicating a time range of stream data that is a processing target among the plurality of pieces of the stream data, and the time information assigned to the extracted plurality of pieces of stream data.

9. The recording medium according to claim 6,
wherein the stream data processing apparatus manages a time of a computer system, and
wherein the second procedure comprises a procedure of calculating the second reference time by using the first reference time closest to the time of the computer system among the first reference times of the plurality of pieces of input information.

10. The recording medium according to claim 6,
wherein the stream data processing apparatus receives adjustment accuracy information and adjustment time information that are used for determining the second reference time, and
wherein the second procedure comprises a procedure of calculating the second reference time based on a comparison result of the input interval and the first reference time among the plurality of pieces of the stream data for the each of the plurality of pieces of input information, the adjustment accuracy information, and the adjustment time information.

11. A stream data processing apparatus that receives stream data including time information and executes processing according to a query registered in advance, comprising:
a processor; and
a memory connected to the processor,
wherein the memory comprises:
a stream data reception module for receiving a plurality of pieces of input information including a plurality of pieces of the stream data;
a time information analysis module for analyzing the time information on the plurality of pieces of input information for each of the plurality of pieces of input information;
a time information adjustment module for generating a plurality of pieces of new input information based on an analysis result of the time information analysis module; and
a stream data processing module for executing the processing according to the query for each of the plurality of pieces of new input information, and
wherein the steam data processing apparatus is configured to:
extract, for the each of the plurality of pieces of input information, the plurality of pieces of the stream data included in the each of the plurality of pieces of input information, and calculating an input interval of the plurality of pieces of the stream data and a first reference time that is a processing time of the plurality of pieces of the stream data;
calculate, based on the input interval and the first reference time calculated for the each of the plurality of pieces of input information, a second reference time that is a new processing time of the plurality of pieces of input information; and
generate, based on the second reference time, stream data having new time information assigned thereto for the each of the plurality of pieces of input information.

12. The stream data processing apparatus according to claim 11, which is further configured to process the plurality of pieces of input information based on the new time information.

13. The stream data processing apparatus according to claim 11, which is further configured to calculate, in a case of the second reference time is calculated, the second reference time based on time accuracy defined in the query for executing the processing by using the plurality pieces of the stream data included in the plurality of pieces of input information and indicating a time range of stream data that is a processing target among the plurality of pieces of the stream data, and the time information assigned to the extracted plurality of pieces of stream data.

14. The stream data processing apparatus according to claim 11, which is further configured to:
manage a time of a computer system; and
calculate, in a case of the second reference time is calculated, the second reference time assigned thereto is generated, the new time information by using the first reference time closest to the time of the computer system among the first reference times of the plurality of pieces of input information.

15. The stream data processing apparatus according to claim 11, further comprising a time information definition setting module for receiving adjustment accuracy information and adjustment time information that are used for determining the second reference time,
wherein the stream data processing apparatus is further configured to calculate, when the second reference time is calculated, the second reference time based on a comparison result of the input interval and the first reference time among the plurality of pieces of the stream data for the each of the plurality of pieces of input information, the adjustment accuracy information, and the adjustment time information.
